(19) United States
(12) Patent Application Publication
(10) Pub. No.: US 2006/0238943 A1
(43) Pub. Date: Oct. 26, 2006

(54) Display device and method for driving a display device

(76) Inventors: Hiroki Awakura, Yokohama (JP); Naruhiko Kasai, Yokohama (JP); Toshihiro Satou, Mobara (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/401,225

(22) Filed: Apr. 11, 2006

(30) Foreign Application Priority Data
Apr. 20, 2005 (JP) 2005-121836

(51) Int. Cl. H02H 3/08

(52) U.S. Cl. 361/93.1

(57) ABSTRACT

A display device with a pulse width modulation system in the invention includes a current measuring circuit for measuring a peak current value of a pixel, a reference current value calculating circuit for calculating a reference current value according to at least one of cumulative use time of the pixel and a degraded condition of the pixel, and an anode power supply circuit for controlling the peak current value of the pixel, aiming for the reference current value as a target.

### CLAIM OF PRIORITY

The present application claims priority from Japanese application serial no. 2005-121836 filed on Apr. 20, 2005, the content of which is hereby incorporated by reference into this application.

### BACKGROUND OF THE INVENTION

The present invention relates to a display device which applies pulse width modulation (PWM) to display of gradations, and a method for driving the same. More particularly, the invention relates to a display device including a spontaneous light emitting type display element, such as an organic electroluminescent element (organic EL element), or a field emission display element (FED element), and a method for driving the same.

In recent years, a panel type display device has been put to practical use which includes a plurality of pixels arranged in a matrix on an insulating substrate, instead of a cathode tube. Particularly, as one of the panel type display devices, a liquid crystal display has already come into practical use. The liquid crystal display does not emit light itself, and thus requires outside light or an auxiliary light source to visualize images. In contrast, a spontaneous light emitting type display device with pixels emitting light itself has been developed. As the spontaneous light emitting type display device, the organic EL, and the FED are well known.

Generally, the spontaneous light emitting element, such as the organic EL, or the FED, has a feature that allows light emission luminance thereof to be proportional to an amount of current passing through the element. Thus, in order to create the gradation on pixels accurately, the amount of current passing through each pixel should be controlled with precision. For example, in the organic EL display, a thin film transistor (TFT) serves as an element for controlling the amount of current passing through each pixel, namely, a current control element. In order to achieve the uniform display of the pixels over the entire surface of the display device, it is necessary to control the amount of analog current uniformly over all pixels. This requires manufacturing a current control element having the uniform characteristics over an entire display area of the display device. However, it is difficult under the present circumstances to manufacture the TFT serving as a typical active element for use in the display area and having the uniform characteristics over the entire display area.

As one of gradation display systems without needing the TFT having the uniform characteristics, a PWM system has been proposed. The PWM gradation display system performs a gradation display method which involves controlling the TFT of each pixel by binary values, including ON (lighting on) and OFF (lighting off), and then displaying the gradation by the interval of lighting-on time during one frame period. Such binary control by ON and OFF does not affect the display quality even under any fluctuations in the characteristics of TFT.

The PWM gradation display systems are classified into a digital PWM system, and an analog PWM system, according to a difference in the method for controlling a pulse width of lighting.

The digital PWM system performs the gradation display by dividing one frame period into some sub-frames, setting the ratio of length of one sub-frame to that of the adjacent one to 1:2:4:8:16 etc., and displaying the gradation by a combination of lighting on and off of the respective sub-frames in a binary digital format. This digital PWM system has an advantage in that the pixels can be constructed by a simple circuit, but has to operate a driving circuit at high speeds so as to repeatedly control switching between lighting on and off conditions during one frame period. Furthermore, an influence of the lighting on and off operation of the adjacent pixels causes a phenomenon called pseudo outline, in which an outline is visible at a place where it cannot be seen basically when a user's eyes move, for example.

On the other hand, JP-A-235370/2000 discloses the analog PWM system. That is, in the analog PWM system, pixels of all gradations each are lighted on once during one frame period (that is, the lighting-on time is continuous during the one frame period), and thus the driving circuit may operate at low speeds as compared to the digital PWM system, with no pseudo outline phenomenon.

In order to put the spontaneous light emitting type display such as the organic EL into practical use, there arises another problem that the luminance of the display is reduced accompanied by degradation in element, in addition to the problem of the display uniformity as described above. In the spontaneous light emitting type display device, when the lighting is continued for a long time, the degradation in the light emitting element may progress, resulting in a decreased amount of current passing through the emitting element, thus leading to reduction in light emission luminance.

To deal with the problem of the reduction in luminance due to the degradation in the light emitting element, and due to the decreased amount of the light emitting current, U.S. Pat. No. 6,710,548 (JP-A-311898/2002) discloses a technique for correcting a driving voltage for a light emitting element by monitoring a driving current for the element such that the driving current remains constant even if degradation in the light emitting element progresses.

More specifically, the technique employs a method for correcting the driving voltage for the light emitting element, which comprises the steps of measuring the total amount of current for all circuits of the element, comparing the current amount measured with a reference current amount, and correcting the driving voltage for the light emitting element based on a result of the comparison. When a displayed image is changed into another, the total amount of current for all the circuits of the light emitting element may also be changed. Thus, in the technique as disclosed in the above U.S. Pat. No. 6,710,548, the reference amount of current is calculated from a video signal, and is set for every displayed image, thereby solving the problem of change in the total amount of the current.

### SUMMARY OF THE INVENTION

The spontaneous light emitting type light emitting element may be degraded throughout long periods of use and emission, which leads to reduction in the light emission luminance. The factors responsible for the reduction in the light emission luminance are classified into two types from a viewpoint of an electric circuit: a decrease in an amount of current passing through the light emitting element due to degradation in a current-voltage characteristic (I-V characteristic) of the light emitting element; and reduction in luminance due to degradation in a luminance-current characteristic (L-I characteristic).

When the light emitting element is driven with a driving voltage applied thereto being constant, the light emitting element is affected by the degradation in both of the I-V characteristic and the L-I characteristic, which leads to the reduction in luminance accompanied by the progressing degradation.

In contrast, when a driving voltage applied to the light emitting element is controlled to keep the amount of the current passing through the element constant even if the degradation of the element progresses, the decreased amount of current due to the degradation in the I-V characteristics is cancelled, so that the reduction in luminance accompanied by the progressing degradation of the element is diminished as compared to the case of the constant driving voltage. The reduction in luminance due to the degradation in the L-I characteristics of the light emitting element, however, is maintained. That is, the technique as disclosed in the U.S. Pat. No. 6,710,548 fails to contemplate preventing the reduction in luminance due to the degradation of the L-I characteristic.

It is an object of the invention to provide a display device which prevents reduction in luminance due to degradation in the L-I characteristic, and a method for driving the same.

It is another object of the invention to provide a display device which prevents the reduction in luminance due to degradation in pixels effectively, as compared to the system for controlling the driving voltage to keep the amount of current passing through the pixel constant, and a method for driving the same.

It is a further object of the invention to provide a display device which prevents the reduction in luminance as mentioned above, thereby improving its life, and a method for driving the same.

In the invention, a reference current value is calculated according to at least one of a cumulative use time of the pixel and a degraded condition of the pixel, and a current value of the pixel is measured, and then the reference current value is controlled aiming for the reference current value as a target. The longer the cumulative use time of the pixel, the larger the reference current value is set. The larger the degradation degree of the pixel, the larger the reference current value is set.

According to the invention, the reference current value is calculated according to at least one of the cumulative use time of the pixel and the degradation degree of the pixel, and the current value of the pixel is controlled, aiming for the reference current value as the target, thereby preventing the reduction in luminance due to the degradation of the L-I characteristic. This can improve the life of pixels.

### BRIEF DESCRIPTION OF THE DRAWINGS

FIG. 1 is a block diagram showing an example of the configuration of an organic EL element display device as a spontaneous light emitting type display device according to a first preferred embodiment of the invention;

FIG. 2 is a schematic diagram of a main pixel structure of a display panel 14 of FIG. 1;

FIG. 3 is a diagram explaining a relationship between an analog signal voltage input to a PWM circuit of FIG. 2 and a lighting-on time of an organic EL element-24;

FIG. 4 is a diagram explaining a waveform of current passing through the organic EL element in the organic EL display device of FIG. 1, and contributing to light emission;

FIG. 5 is a graph explaining a luminance-temperature characteristic of the organic EL element when applying various levels of voltages thereto;

FIG. 6 is a graph showing an example of controlling the lighting luminance of the display device with respect to a cumulative lighting time of the display device;

FIG. 7 shows an example of the configuration of a timer 193 and a reference current value calculating circuit 195 in the organic EL display device of FIG. 1;

FIG. 8 is a block diagram explaining an example of the configuration of an organic EL element display device as a spontaneous light emitting type display device according to a second preferred embodiment; and

FIG. 9 is a block diagram explaining an example of the configuration of an organic EL element display device as the spontaneous light emitting type display device according to a third preferred embodiment.

### DETAIL DESCRIPTION OF THE PREFERRED EMBODIMENTS OF THE INVENTION

In an active matrix type display device driven by a PWM system according to the invention, a total amount of current passing through pixels within the display device and contributing to light emission is measured, and the peak of the current amount which tends to increase and decrease in a cycle of one frame period is monitored. A voltage applied to pixels is controlled so as to gradually increase the peak of the current amount, depending on progressing of degradation in the pixels, thereby preventing reduction in light emission luminance of the pixels.

That is, when the degradation in the pixels progresses, the light emission luminance thereof is gradually reduced. In order to compensate for the reduction in luminance, the amount of current passing through the pixels is gradually increased, and a rate of decrease in the light emission luminance is reduced, thus resulting in a spontaneous light emitting type display device having a long life.

In increasing the amount of current passing through the pixels, the amount of current may be increased so as not to reduce the light emission luminance of the pixels at all. Alternatively, the amount of current may be increased, while allowing for the reduction in luminance due to degradation in the element to some extent. A cumulative use time of the display device may be measured, and based on the cumulative use time measured, a degraded condition of the pixel may be estimated thereby to control an increase in the amount of current. Furthermore, since a damage to the display element is changed depending on images, video data may be monitored, and the cumulative degradation of the pixels may be estimated to thereby control the increase in the current amount. Moreover, a constant current may be fed to the display device once to a plurality of times during a predetermined period after starting up the display device. A current-voltage characteristic (I-V characteristic) of the pixel may be measured from a voltage required at that time. Using a feature that the progressing of the degradation in the pixel causes a change in the I-V characteristic, the degraded condition of the pixel may be estimated.

For a color display system using three kinds of pixels corresponding to red (R), green (G), and blue (B), an amount of current may be measured for every pixel of each color, and the current may be controlled according to the degraded conditions of the respective pixels, thereby reducing deviation of color balance due to fluctuations in degradation rates of the three kinds of pixels.

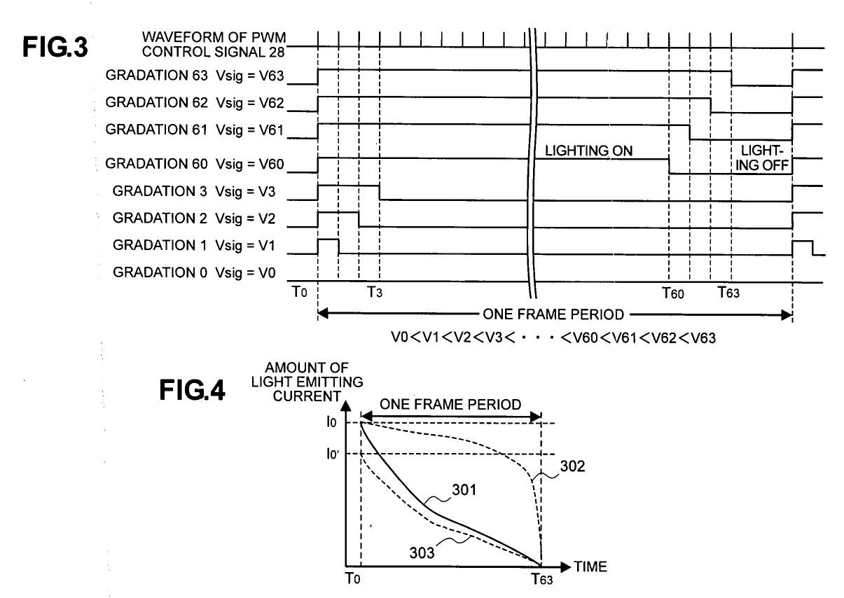

It should be noted that in most cases, a measurable amount of current in the active matrix display device when controlling the current amount as mentioned above is an amount of current passing through the pixels in a range of one line to the entire display surface within the display device. Thus, even under the same condition of degradation of the pixels, the current amounts measured are different from one another, depending on the video data. For this reason, the embodiment utilizes the feature of the spontaneous light emitting display device that performs the gradation display by the PWM system. FIG. 3 shows an outline of a lighting on and off control of the pixels at respective gradations in the display device for performing the gradation display in the PWM system. During one frame period from the time of all pixels being lighted on to the time of all pixels being lighted off, the pixels are gradually lighted off according to the respective gradations, and hence the gradation display is performed by controlling the interval of the lighting-on time of each pixel. As mentioned above, in the display device for performing the gradation display using the PWM system, there is one moment during one frame period when all the pixels are lighted on, regardless of displayed images. The light emitting current is controlled to match a peak current amount with a target amount of current, thereby preventing the reduction in luminance due to the degradation of the spontaneous light emitting element.

Note that when increasing the amount of current passing through the pixels, a driving power supply may impose a limitation on electric power to be supplied to a display panel. The limitation may have been constant since starting the use of the display device, or alternatively it maybe increased or decreased depending on the cumulative use time of the device.

Now, first to third preferred embodiments of the invention will be described in detail by taking an organic EL element display device as an example.

### First Preferred Embodiment

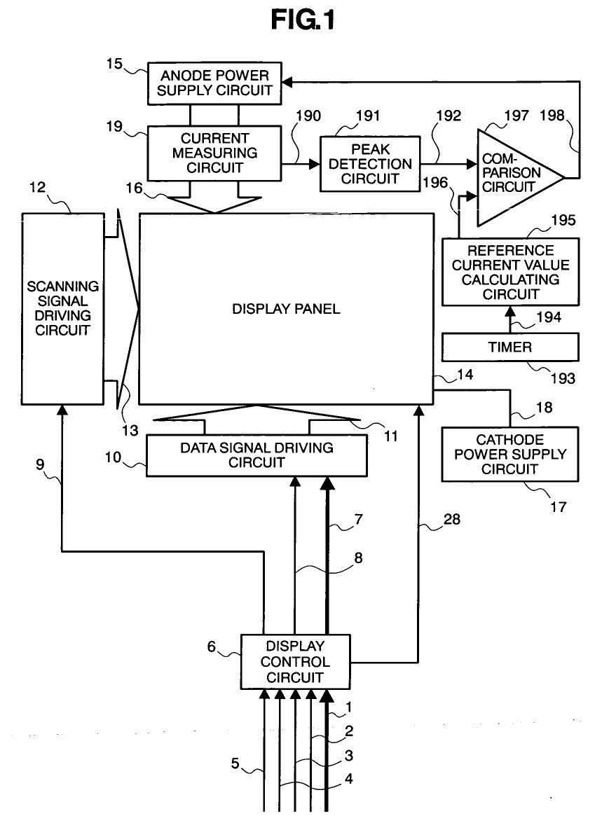

FIG. 1 is a block diagram explaining an example of the configuration of an organic EL element display device as a spontaneous light emitting type display device according to a first preferred embodiment of the invention. Referring to FIG. 1, reference numerals 1 to 5 denote video digital signals input from an external signal source not shown. More specifically, reference numeral 1 denotes a video data signal; reference numeral 2, a vertical sync signal; reference numeral 3, a horizontal sync signal; reference numeral 4, a data enable signal; and reference numeral 5, a data sync clock. The video data signal 1 is a signal indicative of a gray scale (gradation) of each pixel of an image.

The vertical sync signal 2, which is a signal having a cycle of one frame period, indicates a starting point of one frame of the video data signal (display signal) 1. The horizontal sync signal 3, which is a signal having a horizontal cycle, indicates a starting point of one horizontal line of the video data signal 1. The data enable signal 4 is a signal indicative of a period during which the video data signal 1 is valid. All these signals 1 to 4 are input in synchronism with the data sync clock 5. In the present embodiment, the video data signal 1 of one screen is transferred from a pixel positioned on an upper left end of the screen in succession by a raster scan method, which will be explained below in detail.

Reference numeral 6 denotes a display control circuit; reference numeral 7, a display data signal; reference numeral 8, a data signal driving circuit control signal; reference numeral 9, a scanning signal driving circuit control signal; and reference numeral 28, a PWM control signal. The display control circuit 6 controls the entire display device, and outputs the display data signal 7, the data signal driving circuit control signal 8, the scanning signal driving circuit control signal 9, and the PWM control signal 28 at predetermined timing in responsive to the video digital signals 1 to 5 input from the outside. Reference numeral 10 denotes a data signal driving circuit (signal line driving circuit); reference numeral 11, a data line (signal line); reference numeral 12, a scanning signal driving circuit (scanning line driving circuit); reference numeral 13, a scanning line; and reference numeral 14, a display panel.

The data signal driving circuit 10 is controlled by the data signal driving circuit control signal 8, and writes display data (a display signal) in each pixel within the display panel 14 in the form of analog signal (voltage) via the signal line 11. The scanning signal driving circuit 12 is controlled by the scanning signal driving circuit control signal 9 to feed a writing selection signal to the display panel 14 via the scanning line 13. The PWM control signal 28 is a signal for controlling the PWM circuit which is a pixel circuit within the display panel 14. Reference numeral 15 denotes an anode power supply circuit; reference numeral 16, alight-emitting power supply line (current supply line); reference numeral 19, a current measuring circuit; reference numeral 190, a light emitting current signal (current signal); reference numeral 191, a peak detection circuit; and reference numeral 192, a peak current value signal.

The anode power supply circuit 15 supplies power required for emission of the organic EL element to the display panel 14 via the light-emitting power supply line 16.

The peak detection circuit 191 detects an amount of current at the moment when the light emitting current signal 190 reaches its peak, and outputs the peak current value signal 192. Note that instead of the peak current value, the amount of the current (the total amount) may be detected. Reference numeral 193 denotes a timer; reference numeral 194, a cumulative lighting time signal; reference numeral 195, a reference current value calculating circuit; and reference numeral 196, a reference current value signal. The timer 193 measures a cumulative lighting time of the display device, that is, the use period of the pixel, and outputs the cumulative lighting time signal 194. The reference current value calculating circuit 195 calculates the reference current value signal 196 in response to the cumulative lighting time signal 194. Reference numeral 197 denotes a comparison circuit, and reference numeral 198 denotes a current amount excess/deficiency signal. The comparison circuit 197 compares the size of the peak current value signal 192 with that of the reference current value signal 196 to output the current amount excess/deficiency signal 198. That is, the current amount excess/deficiency signal 198 is a signal based on a difference between the peak current value signal 192 and the reference current value signal 196.

The anode power supply circuit 15 receives the current amount excess/deficiency signal 198, and controls a voltage output to the light-emitting power supply line 16, resulting in control of the current. When the peak current value signal 192 is less than the reference current value signal 196, an output voltage of the anode power supply circuit 15 is increased. When the peak current value signal 192 is more than the reference current value signal 196, an output voltage of the anode power supply circuit 15 is decreased. As mentioned above, the voltage output by the anode power supply circuit 15 is controlled to keep the peak current value 192 substantially equal to the reference current value 196. That is, the peak current value 192 is controlled to be matched with the reference current value 196 as a target. Although the cumulative lighting time of the display device is preferably measured every pixel, it may be measured over the entire display device as a whole.

Reference numeral 17 denotes a cathode power supply circuit, and reference numeral 18 denotes a cathode power supply line. The cathode power supply circuit 17 is connected to each pixel of the display panel 14 on the cathode side of the organic EL element via the cathode power supply line 18.

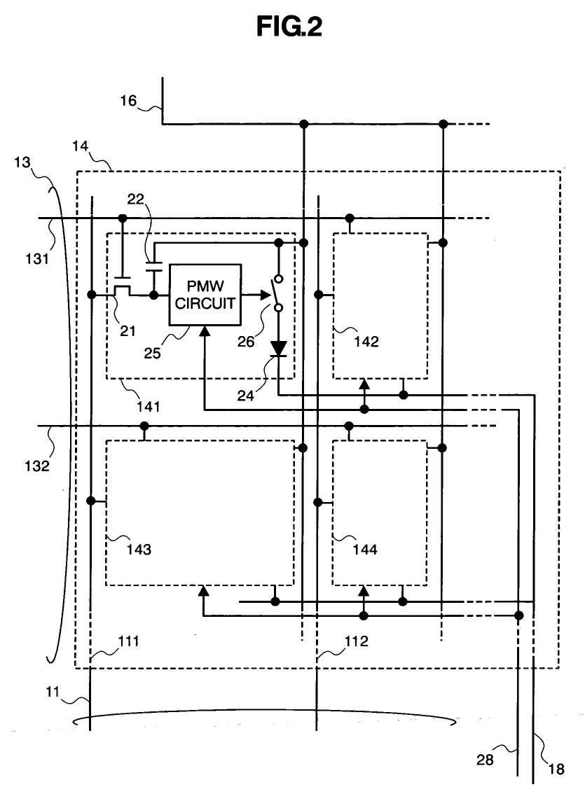

FIG. 2 is a schematic diagram of the main pixel structure of the display panel 14 of FIG. 1. In FIG. 2, reference numeral 111 denotes a first data line, and reference numeral 112 denotes a second data line. Ends of these lines are connected to the data signal driving circuit 10. Reference numeral 131 denotes a first scanning line, and reference numeral 132 denotes a second scanning line. Ends of these lines are connected to the scanning signal driving circuit 12. Although the inside structure of pixels is explained only by taking a pixel 141 on the first line and first column as an example, a pixel 142 on the first line and second column, a pixel 143 on the second line and first column, and a pixel 144 on the second line and second column have the same structure as that of the pixel 141. Reference will now be made to the pixel 141 on the first line and first column as one example.

Reference numeral 21 denotes a switching TFT; reference numeral 22, a data storage capacity; reference numeral 24, an organic EL element; reference numeral 25, a PWM circuit; and reference numeral 26, a lighting switch. The anode side of the organic EL element 24 is connected to the light-emitting power supply line 16 with the lighting switch 26 sandwiched therebetween. The cathode side of the organic EL element 24 is connected to the cathode power supply line 18. The switching TFT 21 has its gate connected to the first scanning line 131, and its drain connected to the first data line 111. When the selection signal is output to the first scanning line by the scanning signal driving circuit 12, the switching TFT 21 is turned on, and a display data signal voltage output to the first data line 111 in the form of analog voltage by the data signal driving circuit 10 is recorded in the data storage capacity 22. The display data signal recorded in the data storage capacity 22 continues to be held by the scanning signal driving circuit 12 after the switching TFT 21 is turned off. Note that the switching element may be any element other than the TFT.

The display luminance of the organic EL element 24 is controlled by performing the on-off control of the voltage applied to the organic EL element 24 to change the rate of the lighting-on time to the lighting-off time during one frame period. The PWM circuit 25 turns on the lighting switch 26 upon receiving a lighting start pulse of the PWM control signal 28 to apply a predetermined voltage to the organic EL element 24, and starts lighting so as to cause the current to pass through the organic EL element 24. Then, the PWM circuit counts pulses given by the PWM control signal 28, and turns off the lighting switch 26 at predetermined timing according to the voltage recorded in the data storage capacity 22 to stop the current passing through the organic EL element 24, thereby lighting off the organic EL element 24. Note that during one frame period, the lighting switch 26 may be repeatedly turned on and off a plurality of times.

FIG. 3 is a diagram explaining a relationship between an analog signal voltage input to the PWM circuit of FIG. 2 and a liqhting-on time of the organic EL element 24. That is, each pixel has its gradation value designated by recording a signal voltage (Vsig) in the data storage capacity 22 through the signal line (data signal line) 111. The figure represents the timing of lighting on and off of such a pixel. Every pixel starts to be lighted on at a time T0. Then, each pixel is lighted off when the number of pulses of the PWM control signal 28 is counted to reach the value according to the gradation designated. In the figure, the time when the pixel having the gradation value x is turned or lighted off is represented by a time Tx. The longer the lighting-on time is during one frame period, the higher the luminance of the pixel becomes.

FIG. 4 is a diagram explaining a waveform of current passing through the organic EL element in the organic EL display device of FIG. 1, and contributing to light emission. Reference numeral 301 denotes a reference light emitting current waveform; reference numeral 302, a light emitting current waveform created when an input video is changed; and reference numeral 303, a light emitting current waveform created when the I-V characteristic is changed.

The light emitting current waveform created with respect to the reference light emitting waveform 301 when an image with a high average luminance is displayed during one or more frame periods is the light emitting current waveform 302 created when the input video signal is changed. In contrast, the light emitting current waveform created with respect to the reference light emitting waveform 301 when the I-V characteristic of the organic EL element is changed due to an effect of degradation in the organic EL element over time with no change of the input video signal, and the amount of current is decreased to reduce the luminance, is the light emitting waveform 303 created when the I-V characteristic is changed.

First, the light emitting waveform 302 created when the input video signal is changed is compared with the reference light emitting current waveform 301. The light emitting waveform 301 has a feature that decreases the amount of light emitting current substantially at a constant pace from the time T0 to T63. Thus, the luminance distribution of the input video signal occurs almost constantly over the gradations zero to 63. For the light emitting current waveform 302, the amount of light emitting current decreases little by little from the time T0, and finally decreases largely just before the time T63. This means that most of pixels are lighted on for a relatively long time during one frame period, and that the luminance distribution of the input video signal is biased toward the high gradation side. The reference light emitting current waveform 301 differs from the light emitting current waveform 302 created when the input video signal is changed, in momentary current value at almost all times except for the time T0 because of different displayed images. However, both waveforms have the same current amount at the time T0 when all pixels are lighted on.

Then, the light emitting current waveform 303 created when the I-V characteristic is changed is compared with the reference light emitting current waveform 301. Since the I-V characteristic is changed in the condition of the current waveform 303 due to degradation of the organic EL element or the like, the current is difficult to pass through, as compared to the current waveform 301. The current amount at the time T0 in the current waveform 303 is I0′/I0 times, as compared to the current waveform 301. Since the input video signal in the case of the current waveform 303 is identical with that in the case of the current waveform 301, the current amounts of the current waveform 303 and the current waveform 301 decreases such that the ratio of I0′/I0 is maintained from the time T0 to the time T63.

As can be seen form the above description, the amount of current at the time T0 when the lighting is started is not affected by the displayed image because all the pixels are lighted on, but affected by the change in the I-V characteristic due to the degradation of the organic EL element or the like. Accordingly, the change in the I-V characteristic due to the degradation in the organic EL element can be evaluated accurately by measuring the amount of current at the time T0, that is, the peak current amount.

Returning now to FIG. 1, the peak current value signal 192 is compared with the reference current value signal 196 by the comparison circuit 197, and based on the result of the comparison, an output voltage of the anode power supply circuit 15 is controlled. Consequently, the output voltage of the anode power supply circuit 15 is controlled such that the peak current value signal 192 has the same level as that of the reference current value signal 196. Thus, the change in the I-V characteristic due to the degradation in the organic EL element or the like can be compensated for.

FIG. 5 is a graph explaining a luminance-temperature characteristic of the organic EL element when applying various levels of voltages thereto, wherein a horizontal axis is a temperature (K), and a vertical axis is a luminance (a.u.). The graph shows the luminance-temperature characteristics when the voltage is 5 V, 6 V, 7 V, 8 V, 9 V, and 10 V. FIG. 5 shows that the light emission luminance is increased significantly with increasing temperature. Also, like the luminance, the amount of current passing through the organic EL element is increased with increasing temperature. It has been known that even when the temperature is changed, the luminance-current characteristic (L-I characteristic) of the organic EL element hardly changes. The change in luminance due to the temperature change is dominated by the change in the I-V characteristic of the organic EL element. In the organic EL element display device of FIG. 1, the change of the I-V characteristic of the organic EL element can be compensated for, so that the change in luminance due to the temperature change can be compensated for almost completely.

It should be noted that when the reference current value signal 196 output from the reference current value calculating circuit 195 remains constant, the reduction in luminance due to the change in the luminance-current characteristic (L-I characteristic) of the organic EL element cannot be compensated for. In the embodiment of the invention, the timer 193 for measuring the cumulative lighting time of the display device and the reference current value calculating circuit 195 are provided to vary the reference current value signal 196 according to the cumulative lighting time of the device. This increases the amount of current passing through the light emitting element depending on the progressing of degradation in the organic EL element, thereby compensating for the reduction in luminance due to the change in the L-I characteristic of the EL element. The way to increase the current amount is set depending on the degradation characteristic of the display panel 14.

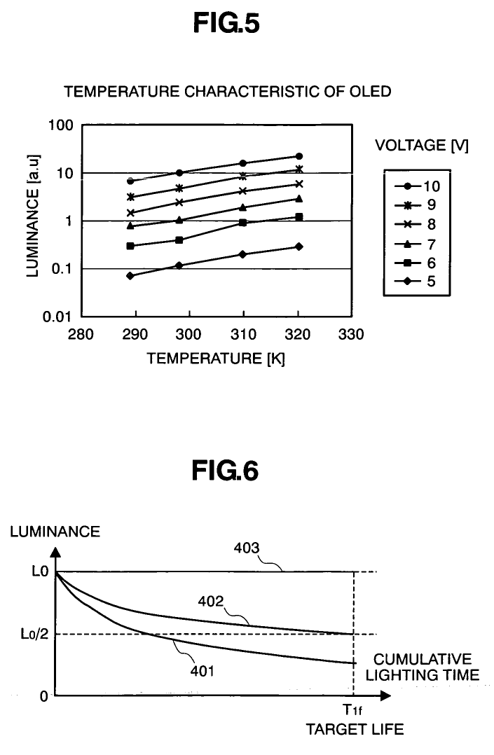

FIG. 6 is a graph showing an example of controlling the lighting luminance of the display device with respect to the cumulative lighting time of the display device. Reference numeral 401 denotes a reference luminance reduction curve; reference numeral 402, a luminance reduction curve aiming for a target life; and reference numeral 403, a luminance reduction curve in which the luminance is completely compensated for. In FIG. 6, a mark L0 denotes an initial luminance, and a mark L0/2 denotes a half of the initial luminance. A mark T1f denotes the target life of the display device.

The reference luminance reduction curve 401 is a luminance reduction curve obtained when the display device is driven with the amount of light emitting current being kept constant. On the other hand, the luminance reduction curve aiming for the target life 402 is a luminance reduction curve obtained in a case where the amount of light emitting current of the display panel 14 is gradually increased, while allowing for the reduction of luminance to some extent, and the display luminance is controlled to be a half of the initial luminance when the display device reaches the target life. The luminance reduction curve 403 with the luminance being completely compensated for is a luminance reduction curve obtained when the light emission luminance of the display device is controlled to remain at the initial level.

The luminance reduction curves as shown in FIG. 6 are obtained by one circuit serving as an example of a light emission luminance control. The invention is not limited to the method for controlling light emission luminance as disclosed herein, and any other control method may be set considering the target life and power consumption of the display device. Although the reference luminance reduction curve 401 reaches a half of the initial display luminance at earlier time than the target life, an object to which a control process for increasing the light emitting current amount is applied is not limited to a display device which does not reach the target life yet. A control process for increasing the light emitting current amount may be applied to any other display device which has already reached the target life.

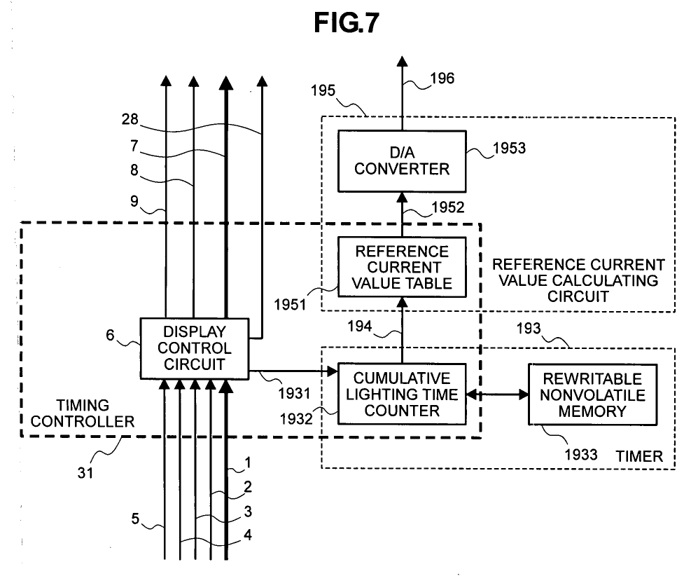

FIG. 7 illustrates an example of a circuit configuration of the timer 193 and the reference current value calculating circuit 195. Reference numeral 31 denotes a timing controller; reference numeral 1931, a reference clock; reference numeral 1932, a cumulative lighting time counter; reference numeral 1933, a rewritable nonvolatile memory; reference numeral 1951, a reference current value table; reference numeral 1952, a reference current value digital signal; and reference numeral 1953, a D/A converter.

The timing controller 31 is a digital circuit, which is an integrated circuit that mainly constitutes the display control circuit 6. In the present embodiment, the timer 193 and one circuit of the reference current value calculating circuit 195 are provided within the timing controller 31. The reference clock 1931 is used to give a reference time to the cumulative lighting time counter 1932. Although in FIG. 7, the reference clock is generated from the display control circuit 6 in one example, the invention is not limited thereto. Any other source for generating a reference time may be used.

The cumulative lighting time counter 1932 counts the time interval during which the display device is lighted on. The counter 1932 counts the reference clock 1931, which becomes a basis of the lighting time of the organic EL element under the PWM control, and then stores a result of the count (cumulative lighting time) in the rewritable nonvolatile memory 1933 when the power supply of the display device is turned off. When the display device is started up again, the counter 1932 reads out the count result (cumulative lighting time) stored in the previous use, and starts to count the reference clock 1931 again with a read value set as an initial value. The counted value is output as the cumulative lighting time signal 194. The rewritable nonvolatile memory consists of an EEPROM or the like, and is designed to hold the cumulative lighting time of the display device even while the power supply of the display device is being turned off. The members 1931, 1932, and 1933 constitute the timer 193 of FIG. 1.

The reference current value table 1951 derives an amount of current passing through the light emitting element of the display panel 14, which is the basis according to the degraded condition of the organic EL element in response to the cumulative lighting time signal 194. Since the reference current value table 1951 is constructed by the digital circuit, the reference current value digital signal 1952, which is an output signal, is also a digital signal. The reference current value digital signal 1952 is converted into an analog signal by the D/A converter 1953 to be output as the reference current value signal 196, which is then input to the comparison circuit 197 shown in FIG. 1. Instead of the table, a mathematical formula may be used. The longer the cumulative lighting time of the display device is, the larger the reduction degree of pixels becomes, and hence the larger the reference current value signal 196 is rendered.

Although in FIG. 7, the timer 193 and the reference current value calculating circuit 195 constitute the digital circuit for controlling the entire display device, the invention is not limited to this configuration of FIG. 7. Any other means having functions of measuring the cumulative lighting time of the display device and of calculating the reference current amount may be employed.

Although FIGS. 1 and 2 illustrate only one system including the anode power supply circuit 15 serving as a power supply on the anode side of the spontaneous light emitting element, the light-emitting power supply line 16, and the current measuring circuit 19, the invention is not limited thereto. These circuits may be provided for each color, such as RGB, and thus a voltage applied to the spontaneous light emitting element may be controlled for every color. The individual provision of the power supply line for every color cannot only adjust color balance at initial setting, but also correct the deviation of color balance due to the temperature change, or due to a difference in degradation rate of the spontaneous light emitting element for every color over time.

Although in the embodiment, the amount of current supplied from the power supply on the anode side of the spontaneous light emitting element is measured, and feedback control is applied to the anode power supply circuit 15, which is a power supply for light emitting, the invention is not limited thereto. The amount of light emitting current may be measured on the cathode power supply line 18, which is a light emitting power supply line on the cathode side of the spontaneous light emitting element. Alternatively, an output voltage of the cathode power supply circuit 17 may be controlled.

When the voltage applied to the spontaneous light emitting element is increased, and also the amount of current passing through the spontaneous light emitting element is increased, the power supplied to the display panel 14, by the driving power supply on the anode side or cathode side may be imposed a limitation on. The limitation may have been constant since when the use of the display device is started, or may be increased or decreased according to the cumulative use time.

### Second Preferred Embodiment

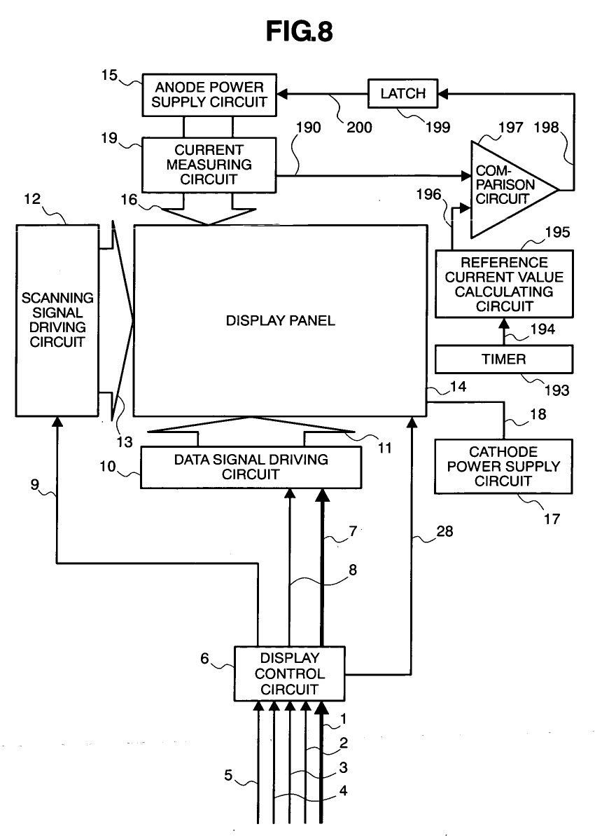

FIG. 8 is a block diagram showing an example of the configuration of an organic EL element display device as a spontaneous light emitting type display device according to a second preferred embodiment.

Reference numeral 199 denotes a latch 199, and reference numeral 200 denotes a current amount excess/deficiency signal when the current reaches its peak. The latch 199 latches the current amount excess/deficiency signal 198 at the moment when the amount of current passing through the light-emitting power supply line 16 reaches its peak, and outputs the current amount excess/deficiency signal 200 created when the current peaks. That is, the excess/deficiency of the current amount is detected.

The different point from FIG. 1, which is the block diagram of the first embodiment, is that no peak detection circuit 191 exists, the light emitting current signal 190 from the current amount measuring circuit 19 is directly input to the comparison circuit 197, and the current amount excess/deficiency signal 198 output from the comparison circuit is latched by the latch 199 once to be input to the anode power supply circuit. The other circuit part is the same as that of the first embodiment.

The comparison circuit 197 continues to output the result of comparison with the reference current value signal 196 even when the light emitting current signal 190 does not peak (current amount excess/deficiency signal 198). Since the latch 199 performs sampling only at the moment when the current amount peaks, consequently, the current amount excess/deficiency signal 200 created when the current amount peaks in FIG. 8 has the same output result as that of the current amount excess/deficiency signal 198 of FIG. 1.

If the moment when the current peaks can be designated into the latch 199, then the configuration of FIG. 8 can be achieved. The configuration of the second preferred embodiment has an advantage in that an expensive analog sample hold circuit is unnecessary.

### Third Preferred Embodiment

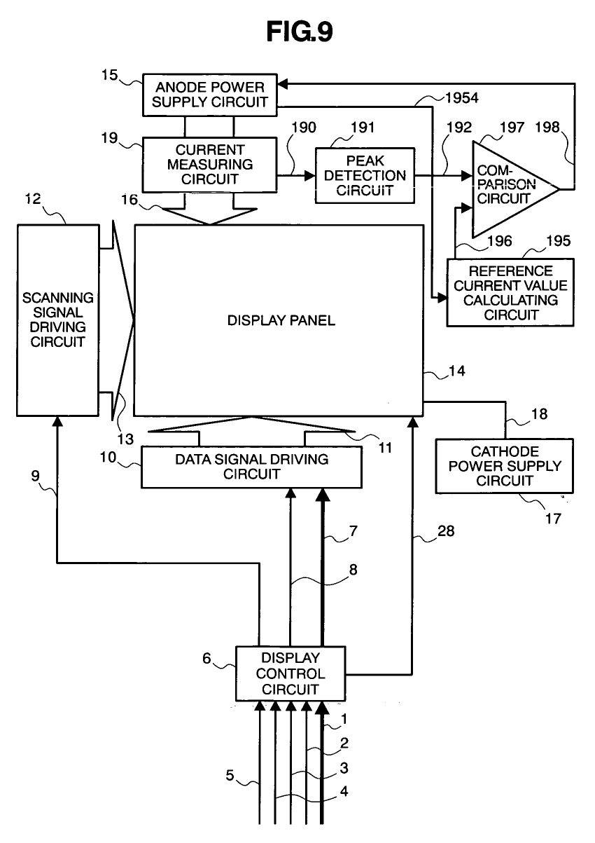

FIG. 9 is a block diagram showing an example of the configuration of an organic EL element display device as a spontaneous light emitting type display device according to a third preferred embodiment.

Reference numeral 1954 denotes an output voltage signal. Through the output voltage signal 1954, the power supply voltage for the light emission of the organic EL element output from the anode power supply circuit 15 is transmitted to the reference current value calculating circuit 195.

The different point from FIG. 1, which is the block diagram of the first embodiment, is that the reference current value calculating circuit 195 estimates the degraded condition of the organic EL element based on the output voltage of the anode power supply circuit 15 and not on the cumulative lighting time of the display device measured by the timer 193, thereby calculating the reference current value signal 196.

To understand the degraded condition of the organic EL element within the display panel 14, first the reference current value calculating circuit 195 outputs the reference current value signal 196 of a specific value. At this time, the current as designated by the reference current value signal 196 passes through the organic EL element within the display panel 14. The degraded condition of the organic EL element is understood from the reference current value signal 196 at this time.

When the degradation of the organic EL element progresses, the current-voltage characteristic (I-V characteristic) is degraded, thus making it difficult for the current to pass through it. As the degradation of the organic EL element progresses, the voltage required to cause the current of a constant amount to flow is increased. Using the above-mentioned feature, the degraded condition of the organic EL element is estimated from the output voltage signal 1954 when the constant current passes through the display panel 14, and the reference current value signal 196 is increased and decreased according to the degraded condition of the organic EL element, thereby compensating for the reduction in luminance accompanied by the degradation in the organic EL element.

The invention can be used in display devices, including a TV, a cellular telephone, a PC monitor, and a corner display.

1. A display device with a pulse width modulation system, comprising:
a display panel including a plurality of pixels arranged in a matrix form;
a signal line driving circuit for supplying a signal voltage according to video data from the outside to a signal line connected to the pixel;
a scanning line driving circuit for supplying a selection signal for selecting the pixel to which the signal voltage is to be supplied, to a scanning line connected to the pixel;
a driving power supply circuit for supplying an electric power to the plurality of pixels;
a display control circuit for converting a signal from the outside into a control signal for controlling the signal line driving circuit and the scanning line driving circuit;
a measuring circuit for measuring a current value of the pixel;
a calculating circuit for calculating a reference current value according to at least one of cumulative use time of the pixel and a degraded condition of the pixel; and
a current control circuit for controlling the current value of the pixel, aiming for the reference current value as a target.

2. The display device according to claim 1, wherein the measuring circuit measures a maximum current value created during one frame period of the pixel, as the current value of the pixel.

3. The display device according to claim 1, wherein the measuring circuit measures the current value created when the supply of the power is started by the driving power supply circuit during one frame period of the pixel, as the current value of the pixel.

4. The display device according to claim 1, wherein the current control circuit controls the current value of the pixel by controlling a voltage of the power supplied to the pixel by the driving power supply circuit.

5. The display device according to claim 1, wherein the pixels include a red pixel, a green pixel, and a blue pixel, and wherein the current control circuit individually controls the current value of the red pixel, the current value of the green pixel, and the current value of the blue pixel.

6. The display device according to claim 5, wherein the measuring circuit individually measures the current value of the red pixel, the current value of the green pixel, and the current value of the blue pixel.

7. The display device according to claim 1, wherein the driving power supply circuit imposes a limitation on the power supplied to the pixel.

8. The display device according to claim 1, further comprising:
a time measuring circuit for measuring cumulative use time of the display device; and
an estimating circuit for estimating a degraded condition of the pixel based on the cumulative use time of the display device.

9. The display device according to claim 8, further comprising:
a measuring circuit for measuring an average luminance of video data during one or more frame periods of the video data,
wherein the estimating circuit estimates the degraded condition of the pixel based on the cumulative use time of the display device and the average luminance of the video data.

10. The display device according to claim 8, wherein the estimating circuit estimates that the longer the cumulative use time of the display device is, the larger a degree of degradation in the pixel is.

11. The display device according to claim 1, further comprising an estimating circuit for estimating the degraded condition of the pixel based on the voltage applied to the pixel when a constant current passes through the pixel.

12. The display device according to claim 11, wherein the estimating circuit estimates that the smaller the voltage applied to the pixel is when the constant current passes through the pixel, the larger the degree of degradation in the pixel is.

13. The display device according to claim 1, wherein the calculating circuit calculates the reference current value such that the longer the cumulative use time of the pixel is, the larger the reference current value becomes.

14. The display device according to claim 1, wherein the calculating circuit calculates the reference current value such that the larger the degree of degradation in the pixel is, the larger the reference current value becomes.

15. A method for driving a display device with a pulse width modulation system, said display device comprising a display panel including a plurality of pixels arranged in a matrix form, a signal line driving circuit for supplying a signal voltage according to video data from the outside to a signal line connected to the pixel, a scanning line driving circuit for supplying a selection signal for selecting the pixel to which the signal voltage is to be supplied, to a scanning line connected to the pixel, a driving power supply circuit for supplying an electric power to the plurality of pixels, and a display control circuit for converting a signal from the outside into a control signal for controlling the signal line driving circuit and the scanning line driving circuit, the method comprising the steps of:
calculating a reference current value according to at least one of cumulative use time of the pixel and a degraded condition of the pixel;
measuring a current value of the pixel; and
controlling the current value of the pixel, aiming for the reference current value as a target.
